(19) United States
(12) Patent Application Publication
(10) Pub. No.: US 2015/0375567 A1
(43) Pub. Date: Dec. 31, 2015

(54) INNER TUBE SPOOL

(71) Applicant: Specialized Bicycle Components, Inc., Morgan Hill, CA (US)

(72) Inventors: Daniel Lentz, San Jose, CA (US); Brian M. Szykowny, Sonoma, CA (US)

(21) Appl. No.: 14/316,356

(22) Filed: Jun. 26, 2014

(51) Int. Cl. B60C 5/04; B65D 85/00

(52) U.S. Cl. CPC B60C 5/04; B65D 85/70

(57) ABSTRACT

The present invention provides a spool and tube assembly comprising a spool body having a first spool surface spaced (e.g., including a raised lip) from a second spool surface (e.g., also including a raised lip), and an inner tube wrapped around the first and second spool surfaces of the spool body. Preferably, the spool body includes a stem recess (e.g., formed in the first spool surface) for receiving a valve stem on the inner tube. The second spool surface can include a notch adapted to receive and hole a pump head. In addition, the spool body can include a cutout adapted to receive and hold a pressurized gas cartridge, and a protrusion adapted to receive and hold a tire lever. A strap can be provided for securing the inner tube on the spool body.

### BACKGROUND

The present invention relates generally to bicycle tools and accessories, and particularly to a device for storing a bicycle inner tube.

Cyclists often carry tools to facilitate bicycle repair during a ride. In order to attend to a flat tire, cyclists often carry a spare tube, a tire lever that assists with removing the tire from the rim, and a pump or compressed gas for inflating the tire.

### SUMMARY

The present invention provides a spool and tube assembly comprising a spool body having a first spool surface spaced (e.g., including a raised lip) from a second spool surface (e.g., also including a raised lip), and an inner tube wrapped around the first and second spool surfaces of the spool body. Preferably, the spool body includes a stem recess (e.g., formed in the first spool surface) for receiving a valve stem on the inner tube. The second spool surface can include a notch adapted to receive and hole a pump head. In addition, the spool body can include a cutout adapted to receive and hold a pressurized gas cartridge, and a protrusion adapted to receive and hold a tire lever. A strap can be provided for securing the inner tube on the spool body.

Other aspects of the invention will become apparent by consideration of the detailed description and accompanying drawings.

### BRIEF DESCRIPTION OF THE DRAWINGS

FIG. 1 is an exploded perspective view of a tube spool embodying the present invention and accessories.

FIG. 2 is an assembled view the tube spool and accessories of FIG. 1.

FIG. 3 is a perspective view of step 1 of an inner tube being mounted on the tube spool of FIG. 1.

FIG. 4 is a perspective view of step 2 of an inner tube being mounted on the tube spool of FIG. 1.

FIG. 5 is a perspective view of the assembly of FIG. 2 with the tube and strap removed.

FIG. 6 is a perspective view of the tube spool.

FIG. 7 is another perspective view of the tube spool.

FIG. 8 is a section view taken along line 8-8 in FIG. 5.

FIG. 9 is a section view taken along line 9-9 in FIG. 5.

FIG. 10 illustrates the tube spool and accessories of FIG. 1 mounted on a bicycle.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

As used herein, integral means that the parts are formed from the same piece of material, without a seam separating the parts. Secured is a broader term that means two portions are held together, such as by a seam, a zipper, or by making the portions integral.

### DETAILED DESCRIPTION

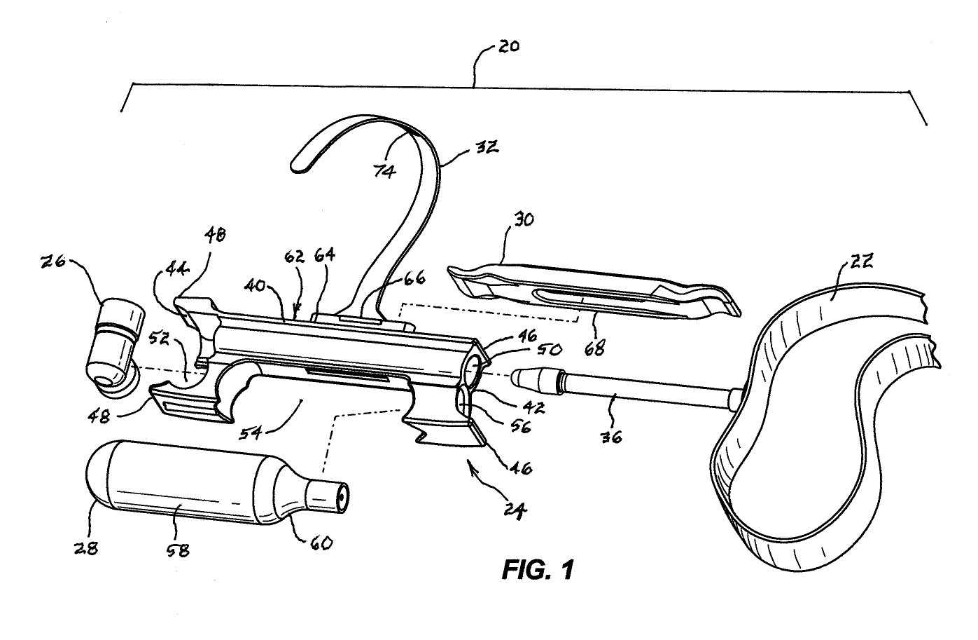

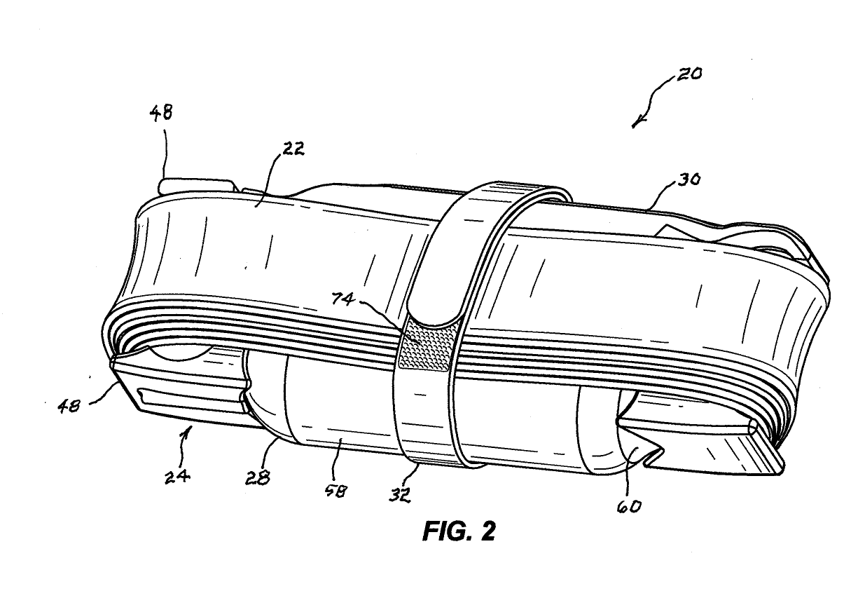

FIGS. 1-2 illustrate a spool and tube assembly 20 embodying the present invention. The illustrated assembly 20 includes an inner tube 22, a spool 24, a pump head 26, a pressurized gas cartridge 28, a tire lever 30, and a strap 32.

The inner tube 22 includes a hollow, resilient and flexible tube and a valve stem 36 coupled to the inner tube 22. The inner tube 22 is formed in the shape of an annulus and is designed to receive pressurized air through the valve stem 36, as is known in the art.

The spool 24 includes a spool body 40 made from a relatively rigid but slightly flexible material, such as nylon plastic, glass-reinforced plastic, or composite. The spool body 40 includes a first spool surface 42 spaced from a second spool surface 44. The first spool surface 42 includes a pair of spaced, raised first lips 46 that cooperate to define a first concave profile dimensioned to receive the inner tube 22. Similarly, the second spool surface 44 includes a pair of spaced, raised second lips 48 that cooperate to define a second concave profile dimensioned to receive the inner tube 22. As best shown in FIG. 4, the inner tube 22 can be wrapped in a spooling pattern around the first and second spool surfaces 42, 44 until the inner tube 22 is completely wound onto the spool body 40.

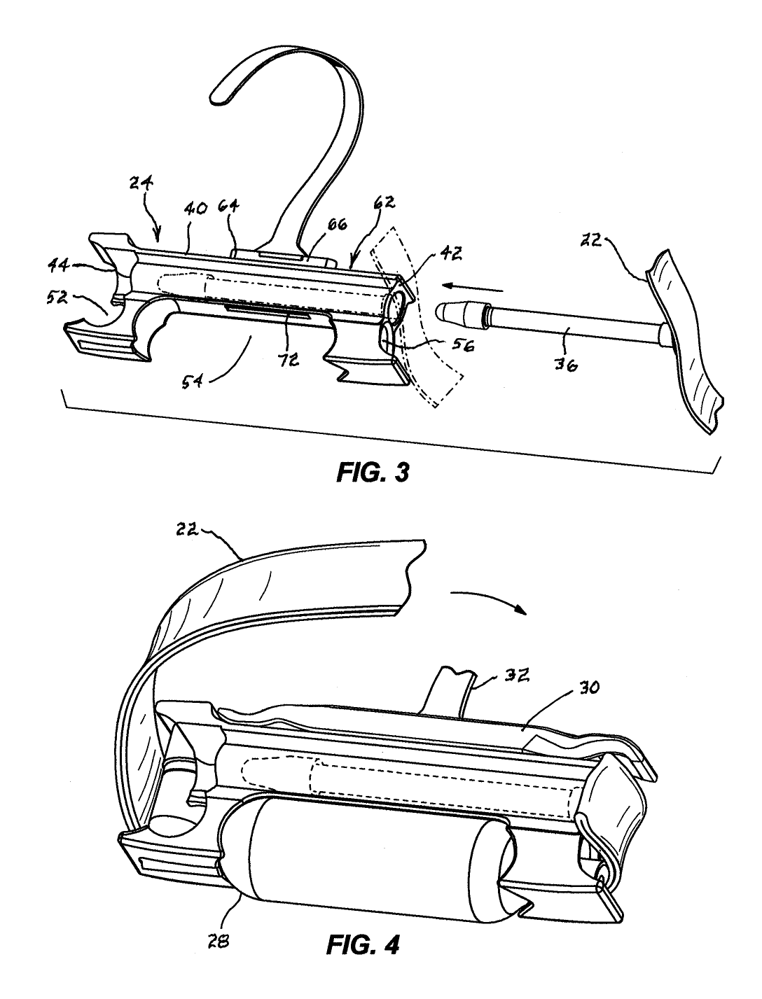

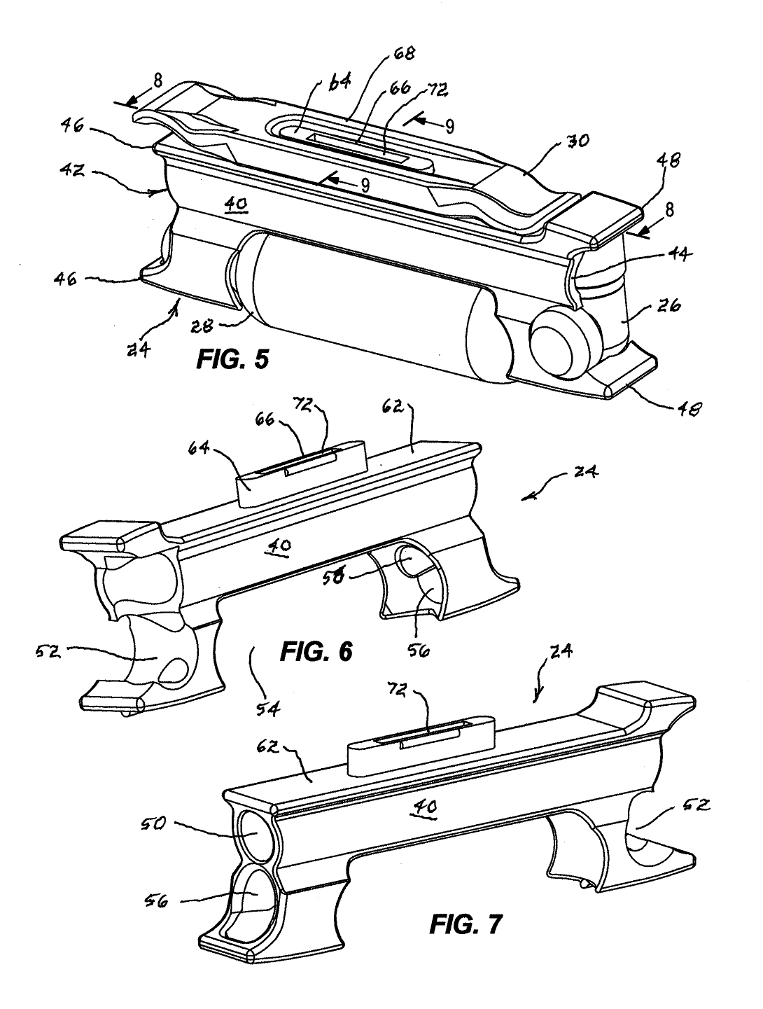

The spool body 40 further includes a stem recess 50 in the form of a through hole formed in the first spool surface 42. Referring to FIG. 3, the stem recess 50 is dimensioned to receive the valve stem 36 when the tube 34 is wrapped onto the spool body 40. It is noted that the stem recess can be embodied in a variety of different structures other than a through hole. For example the stem recess could be a groove, hook, clamp, clip, or any structure that includes a space that receives the valve stem 36 of the tube 34.

The second spool surface 44 of the spool body 40 includes a partially-cylindrical notch 52 dimensioned to securely receive the pump head 26. The pump head 26 is designed to be used when introducing pressurized gas into the inner tube 22. Specifically, the pump head 26 is designed to be engaged with the valve stem 36 to facilitate transfer of pressurized gas from the pressurized gas cartridge 28 into the inner tube 22, as is known in the art.

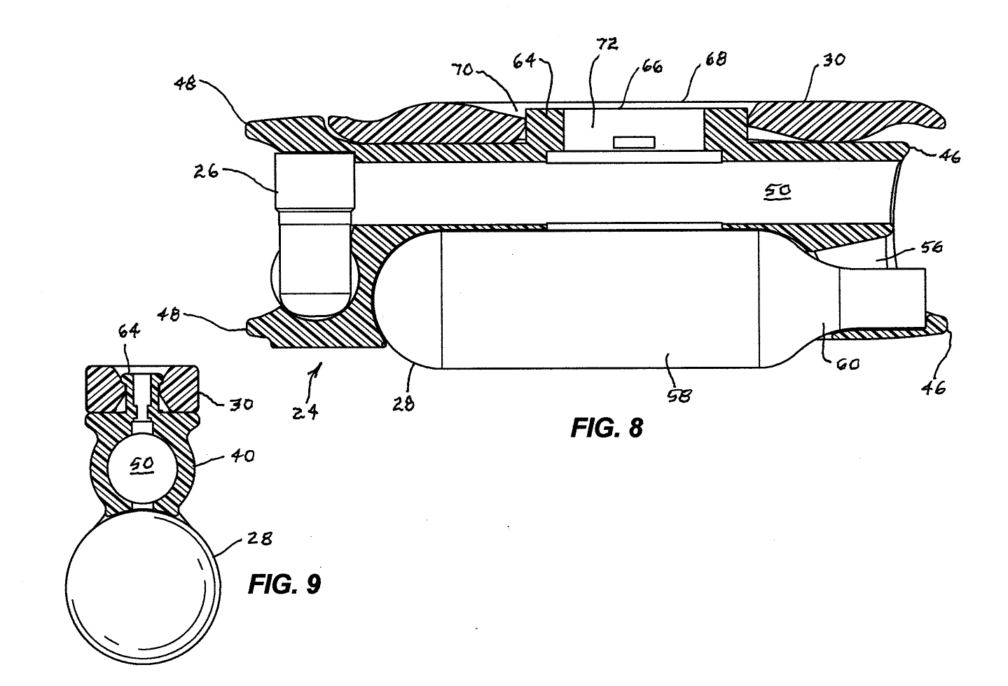

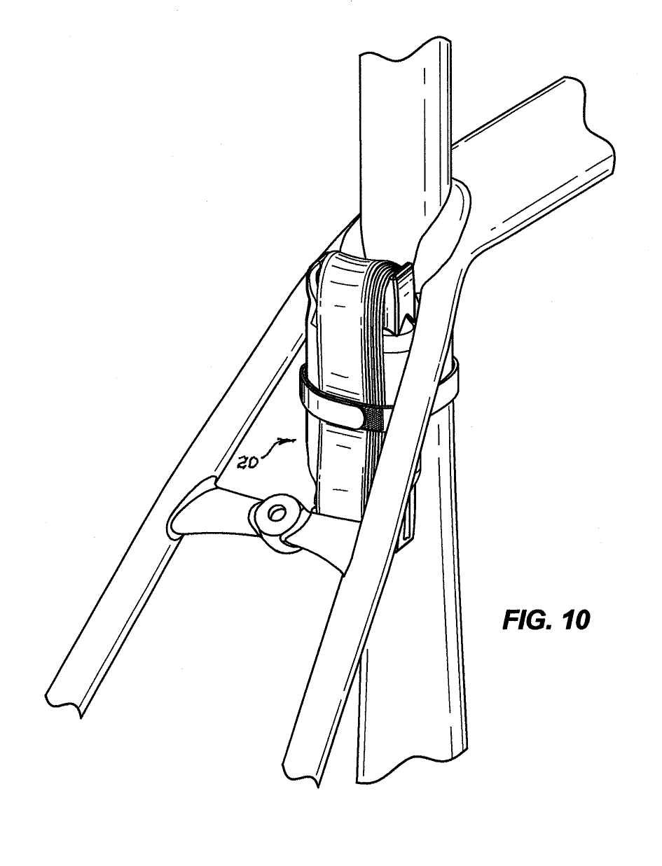

The spool body 40 further includes a cutout 54 between the first and second spool surfaces 42, 44 and a cartridge recess 56 in communication with the cutout 54. The illustrated cartridge recess 56 also communicates with the first spool surface 42, as shown in FIG. 8. The cutout 54 and cartridge recess 56 are dimensioned to receive the gas cartridge 28. Specifically, the cutout 54 is dimensioned to receive a body portion 58 of the gas cartridge 28, and the cartridge recess 56 is dimensioned to receive a neck portion 60 of the gas cartridge 28.

The spool body 40 further includes a side surface 62 having a protrusion 64 with side walls 66 that are dimensioned to support the tire lever 30. Specifically, the tire lever 30 includes side rails 68 that define an elongated aperture 70 dimensioned to be snapped onto the protrusion 64 and held in place on the spool body 40.

The spool body 40 further includes a slot 72 formed through the side surface 62 in the center of the protrusion 64. The slot 72 is dimensioned to receive the strap 32 in order to facilitate securing of the inner tube 22 onto the spool body 40. The strap 32 can be threaded all the way through the slot 72, or one end of the strap 32 can be secured in the slot 72 or otherwise to the spool body 40. The strap 32 includes a hook and loop fastener 74 that facilitates wrapping the strap 32 around the tube 22 and spool body 40 and securing it in place, as best shown in FIGS. 2 and 10.

In operation, the various accessories are mounted onto the spool body 40 as follows. First, if the strap 32 is not already secured to the spool body 40, the strap 32 is threaded through the slot 72 in the spool body 40. The neck portion 60 of the cartridge 28 is inserted into the cartridge recess 56, and the body portion 58 of the cartridge 28 is pivoted toward the spool body 40 until it snaps into the cutout 54. The snapping engagement is facilitated by a slight flexing of the spool body 40. The pump head 26 is snapped into and held in the notch 52, again facilitated by the slight flexibility of the spool body 40. The elongated aperture 70 of the tire lever 30 is snapped onto the protrusion 64 on the side surface 62 of the spool body 40, which is facilitated by flexing of the side walls 66 of the protrusion 64 and corresponding side rails 68 of the tire lever 30.

In order to mount the inner tube 22 onto the spool body 40, the valve stem 36 of the inner tube 22 is first inserted into the stem recess 50 in the spool body 40. The tube 22 is then repeatedly wrapped around the first and second spool surfaces 42, 44 until the tube 22 is completely spooled around the spool body 40. The strap 32 is then wrapped around the tube 22, and the hook and loop fastener 74 is engaged together to hold the strap 32 in place.

Various features and advantages of the invention are set forth in the following claims.

1. A spool and tube assembly comprising:
a spool body having a first spool surface spaced from a second spool surface; and
an inner tube wrapped around the first and second spool surfaces of the spool body.

2. A spool and tube assembly as claimed in claim 1, wherein the spool body includes a stem recess, and wherein the inner tube includes a valve stem positioned in the stem recess.

3. A spool and tube assembly as claimed in claim 2, wherein the stem recess is formed in the first spool surface.

4. A spool and tube assembly as claimed in claim 1, wherein the second spool surface includes a notch, and wherein the assembly further comprises a pump head positioned in the notch.

5. A spool and tube assembly as claimed in claim 1, wherein the spool body includes a cutout, and wherein the assembly further includes a pressurized gas cartridge positioned in the cutout.

6. A spool and tube assembly as claimed in claim 5, wherein the spool body further includes a cartridge recess in communication with the cutout, and wherein the gas cartridge includes a neck positioned in the cartridge recess.

7. A spool and tube assembly as claimed in claim 1, wherein the spool body includes a protrusion, and wherein the assembly further includes a tire lever engaged with the protrusion.

8. A spool and tube assembly as claimed in claim 1, wherein the first spool surface includes a raised lip to hold the inner tube on the spool body.

9. A spool and tube assembly as claimed in claim 1, wherein the first and second spool surfaces each includes a raised lip to hold the inner tube on the spool body.

10. A spool and tube assembly as claimed in claim 1, further comprising a strap securing the inner tube onto the spool body.

11. An inner tube spool adapted to receive an inner tube, the spool comprising:
a first spool surface spaced from a second spool surface; and
a stem recess dimensioned to receive an inner tube valve stem.

12. A inner tube spool as claimed in claim 1, wherein the second spool surface includes a notch dimensioned to receive a pump head.

13. A inner tube spool as claimed in claim 1, wherein the spool body includes a cutout dimensioned to receive a pressurized gas cartridge.

14. A inner tube spool as claimed in claim 5, wherein the spool body further includes a cartridge recess in communication with the cutout, the cartridge recess dimensioned to receive a neck of the gas cartridge.

15. A inner tube spool as claimed in claim 1, wherein the spool body includes a protrusion dimensioned to engage a tire lever.

16. A inner tube spool as claimed in claim 1, wherein the first spool surface includes a raised lip adapted to hold the inner tube on the spool.

17. A inner tube spool as claimed in claim 1, wherein the first and second spool surfaces each includes a raised lip adapted to hold the inner tube on the spool body.

18. A inner tube spool as claimed in claim 1, further comprising a strap adapted to secure the inner tube onto the spool.
